(19) United States
(12) Patent Application Publication
(10) Pub. No.: US 2012/0257119 A1
(43) Pub. Date: Oct. 11, 2012

(54) LIGHTING DEVICE, DISPLAY DEVICE AND TELEVISION RECEIVER

(75) Inventor: Mitsuru Hosoki, Osaka-shi (JP)

(73) Assignee: SHARP KABUSHIKI KAISHA, Osaka-shi, Osaka (JP)

(21) Appl. No.: 13/515,295

(22) PCT Filed: Nov. 17, 2010
(86) PCT No.: PCT/JP2010/070447

§ 371 Date: Jun. 12, 2012

(30) Foreign Application Priority Data
Dec. 23, 2009 (JP) 2009-291568

(51) Int. Cl. F21V 7/04; H04N 5/44

(52) U.S. Cl. 348/725; 362/609; 362/602; 348/E05.096

(57) ABSTRACT

An object of the present invention is to provide a lighting device that can suppress uneven brightness. The lighting device of the present invention includes a LED 22 having a light emitting surface 22A, a light guide plate 50 having a light entrance surface 50D and a light exit surface 50A, and a reflection-type polarizing sheet 43 covering at least a part of the light exit surface 50A of the light guide plate 50. Light emitted from the light emitting surface 22A enters the light entrance surface 50D facing the light emitting surface 22A. The light in the light guide plate 50 exits through the light exit surface 50A. A light-source-side peripheral end 43A of the reflection-type polarizing sheet 43 is located farther from the LED 22 than a light-source-side peripheral end of the light guide plate 50, whereby a peripheral end portion of the light guide plate 50 has a sheet-non-overlapping area T1 that does not overlap with the reflection-type polarizing sheet 43.

### TECHNICAL FIELD

The present invention relates to a lighting device, a display device and a television receiver.

### BACKGROUND ART

In recent years, a thin display element, such as a liquid crystal panel and a plasma display panel, is used as a display element of an image display device. This enables the image display device to have a reduced thickness. When the liquid crystal panel is used as the display element, the liquid crystal panel requires a lighting device (backlight device) as a separate lighting device, because the liquid crystal panel does not emit light.

One example of the lighting device is described in Patent Document 1. The lighting device described in Patent Document 1 includes a plurality of light sources (LEDs, for example) arranged on a side end portion (side edge) of the lighting device, and a light guide plate through which the light emitted from the light sources exits toward a display surface of the liquid crystal panel. The light sources are arranged so as to face a light entrance surface of the light guide plate. The light that enters through the light entrance surface is totally reflected repeatedly within the light guide plate, so that the light is guided and then exits from the light exit surface.

A lighting device that includes a reflection-type polarizing sheet arranged to cover the light exit surface of the light guide plate is also known. In such a lighting device, the reflection-type polarizing sheet transmits p-wave of the light exiting from the light exit surface of the light guide plate and reflects s-wave toward the light guide plate. The reflected s-wave is reflected again by a light reflector (light reflective sheet, for example) that is provided on a surface opposite to the light exit surface of the light guide plate. At that time, the reflected s-wave separates into p-wave and s-wave. Accordingly, the reflection-type polarizing sheet allows the s-wave that is normally absorbed by a polarizing plate included in the liquid crystal panel to be reflected toward the light guide plate and to be reused. Thus, improved brightness is achieved.

### RELATED ART DOCUMENT

### Patent Document

Patent Document 1: Japanese Unexamined Patent Publication No. 2007-293339

### Problem to be Solved by the Invention

Although most of the rays of light emitted from a light source enter a light guide plate through a light entrance surface, some of the rays of light may not enter the light entrance surface and may reach an end portion of a reflection-type polarizing sheet in some cases. Such rays of the light are likely to enter the light guide plate through portions other than the light entrance surface after being reflected by the end portion of the reflection-type polarizing sheet, and then exit from a light exit surface of the light guide plate. Generally, the light guide plate is configured such that the light exiting through the light exit surface shows a predetermined brightness distribution when the rays of light emitted from the light source enter entirely through the light entrance surface. Thus, when the rays of light enter the light guide plate through the portions other than the light entrance surface and exit locally as above, uneven brightness may occur. Especially, the light that enters the light guide plate through the portion other than the light entrance surface via the reflection-type polarizing sheet as above is highly likely to appear locally on an end portion of the light exit surface that is located closer to the light source, that is, on a light-source-side end portion of the light exit surface. This increases the brightness of the light-source-side end portion of the light exit surface compared with the surrounding area. Thus, uneven brightness may occur.

### DISCLOSURE OF THE PRESENT INVENTION

The present invention was accomplished in view of the above circumstances. It is an object of the present invention to provide a lighting device that can suppress uneven brightness. Further, it is another object of the present invention to provide a display device and a television receiver each including the lighting device.

### Means for Solving the Problem

To solve the above problem, a lighting device of the present invention includes a light source having a light emitting surface, a light guide plate having a light entrance surface and a light exit surface, and a reflection-type polarizing sheet covering at least a part of the light exit surface of the light guide plate. The light entrance surface faces the light emitting surface of the light source and through which light emitted from the light source enters the light guide plate. The light in the light guide plate exits through the light exit surface. The reflection-type polarizing sheet is arranged such that a light-source-side peripheral end thereof is located farther from the light source than a light-source-side peripheral end of the light guide plate. Accordingly, a peripheral end portion of the light guide plate has a sheet-non-overlapping area that does not overlap with the reflection-type polarizing sheet.

In the lighting device according to the present invention, the peripheral end portion of the light guide plate has the sheet-non-overlapping area. This suppresses that the rays of light emitted from the light source that do not enter the light entrance surface and reach the peripheral end portion of the light guide plate are reflected by the peripheral end portion of the reflection-type polarizing sheet. With this configuration, the light that does not enter the light entrance surface is less likely to appear locally on the light exit surface of the light guide plate after being reflected by the peripheral end portion of the reflection-type polarizing sheet. Thus, uneven brightness is less likely to occur.

The above lighting device may further include a light absorber configured to absorb light. The light absorber is arranged so as to cover the sheet-non-overlapping area. Some of the rays of light emitted from the light source may not enter the light entrance surface, but reach the peripheral end portion of the light exit surface and pass through the sheet-non-overlapping area. According to this configuration, the rays of light are absorbed by the light absorber covering the sheet-non-overlapping area. By absorbing the light that does not enter the light entrance surface, the light is surely less likely to appear locally on the light exit surface of the light guide plate.

The lighting device may further include a housing member configured to house the light source, the light guide plate, and the reflection-type polarizing sheet. The light absorber may be apart of the housing member that faces the light exit surface of the light guide plate and has a black color. In the case where the light absorber is a part of the housing member that is colored black, a light absorber as a separate member is not required. This reduces the component cost.

The lighting device may further include a light scattering reflector configured to reflect and scatter light. The light scattering reflector is arranged so as to cover the sheet-non-overlapping area. Some of the rays of light emitted from the light source may not enter the light entrance surface, but reach the peripheral end portion of the light exit surface and pass through the sheet-non-overlapping area. According to this configuration, the rays of light are reflected and scattered by the light scattering reflector covering the sheet-non-overlapping area. By reflecting and scattering the light that does not enter the light entrance surface, the light is less likely to appear locally on the light exit surface of the light guide plate. In addition, since the rays of light that do not enter the light entrance surface are reused, the light use efficiency is improved.

Next, to solve the above problem, a lighting device according to another aspect of the present invention includes a light source having a light emitting surface, a light guide plate having a light entrance surface and a light exit surface, a reflection-type polarizing sheet covering at least a part of the light exit surface of the light guide plate, and a light scattering reflector configured to scatter and reflect light. The light entrance surface faces the light emitting surface of the light source and through which light enters the light guide plate. The light in the light guide plate exits through the light exit surface. The light scattering reflector is arranged so as to cover a light-source-side peripheral end portion of a light-source-side surface of the reflection-type polarizing sheet.

In such a lighting device, some of the rays of light emitted from the light source may not enter the light entrance surface, but reach a space between the light exit surface and the reflection-type polarizing sheet. In such a case, the rays of light are reflected by the light scattering reflection sheet. By reflecting and scattering the light that does not enter the light entrance surface, the light is less likely to appear locally on the light exit surface of the light guide plate. This suppresses uneven brightness. In addition, since the rays of light that do not enter the light entrance surface are reused by being reflected and scattered, the light use efficiency is improved.

Next, to solve the above problem, a lighting device according to another aspect of the present invention includes a light source having a light emitting surface, a light guide plate having a light entrance surface and a light exit surface, a reflection-type polarizing sheet covering at least a part of the light exit surface of the light guide plate, and a light absorber configured to absorb light. The light entrance surface faces the light emitting surface of the light source and through which light enters the light guide plate. The light in the light guide plate exits through the light exit surface. The light absorber is arranged so as to cover a light-source-side peripheral end portion of a light-source-side surface of the reflection-type polarizing sheet.

In such a lighting device, some of the rays of light emitted from the light source may not enter the light entrance surface, but reach a space between the light exit surface and the reflection-type polarizing sheet. In such a case, the rays of light are absorbed by the light absorber. By absorbing the light that does not enter the light entrance surface, the light is surely less likely to appear locally on the light exit surface of the lighting device. This suppresses uneven brightness.

An example of the light source is a light emitting diode. This improves brightness and reduces power consumption.

To solve the above problem, a display panel according to the present invention includes the above-described lighting device and a display panel configured to provide display using light from the lighting device.

An example of the display panel is a liquid crystal panel. Such a display device as a liquid crystal display device has a variety of application, such as a television display or a display of a desktop personal computer. Particularly, it is suitable for a large screen display.

To solve the above problem, a television receiver according to the present invention includes the above display device.

### Advantageous Effect of the Invention

According to the present invention, a lighting device that can suppress uneven brightness, a display device and a television receiver each including such a lighting device can be provided.

### BRIEF DESCRIPTION OF THE DRAWINGS

FIG. 1 is an exploded perspective view illustrating a general configuration of a television receiver according to a first embodiment of the present invention;

FIG. 2 is an exploded perspective view illustrating a general configuration of a liquid crystal display device included in the television receiver;

FIG. 3 is a cross-sectional view of the liquid crystal display device taken along a short side in FIG. 2;

FIG. 4 is a cross-sectional view illustrating a comparative example;

FIG. 5 is a cross-sectional view of the liquid crystal display device according to a second embodiment of the present invention taken along the short side; and

FIG. 6 is a cross-sectional view of the liquid crystal display device according to a third embodiment of the present invention taken along the short side.

### BEST MODE FOR CARRYING OUT THE INVENTION

### First Embodiment

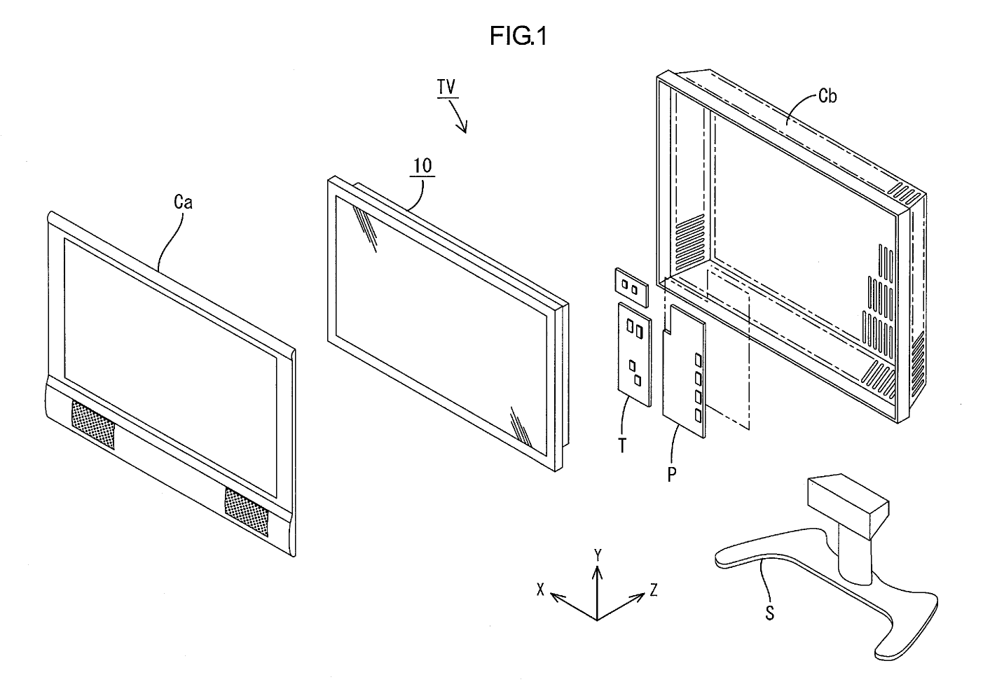

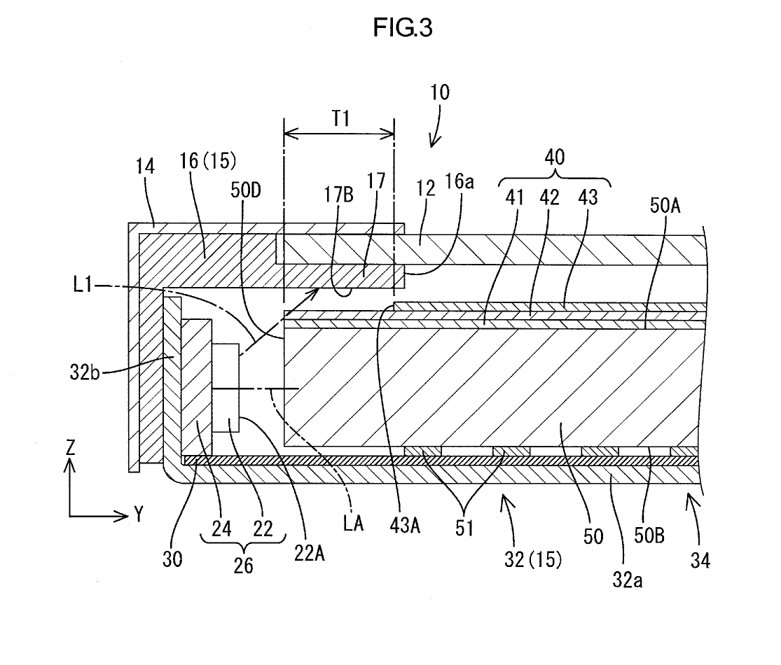

The first embodiment of the present invention will be described with reference to FIGS. 1 to 4. X-axis, Y-axis and Z-axis are indicated in some drawings. The axes in each drawing correspond to the respective axes in other drawings. An upper side in FIG. 3 corresponds to a front side and a lower side in FIG. 3 corresponds to a rear side.

As illustrated in FIG. 1, a television receiver TV of the present embodiment includes a liquid crystal display device 10, front and rear cabinets Ca, Cb which house the liquid crystal display device 10 therebetween, a power source P, a tuner T and a stand S.

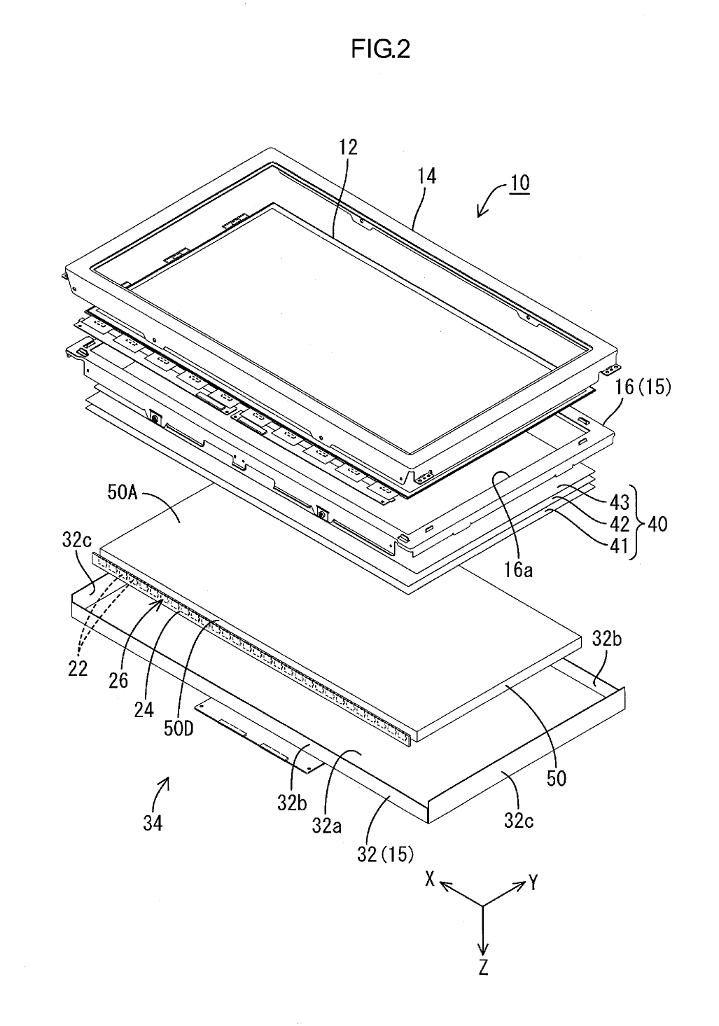

FIG. 2 illustrates the liquid crystal display device 10 in an exploded perspective view. An upper side in FIG. 2 corresponds to a front side and a lower side in FIG. 2 corresponds to a rear side. As illustrated in FIG. 2, an entire shape of the liquid crystal display device 10 is a landscape rectangular. The liquid crystal display device 10 includes a liquid crystal panel 12 as a display panel, and a backlight device 34 as an external light source. The liquid crystal panel 12 and the backlight device 34 are integrally held by a bezel 14 having a frame-like shape.

As illustrated in FIG. 2, the liquid crystal panel 12 included in the liquid crystal display device 10 has a rectangular shape in a plan view. A long side of the liquid crystal panel 12 matches the horizontal direction (X-axis direction) and a short side thereof matches the vertical direction (Y-axis direction). The liquid crystal panel 12 is configured such that a pair of transparent (high light transmissive) glass substrates is bonded together with a predetermined gap therebetween and a liquid crystal layer (not illustrated) is sealed between the glass substrates. On one of the glass substrates, switching components (for example, TFTs) connected to source lines and gate lines which are perpendicular to each other, pixel electrodes connected to the switching components, and an alignment film and the like are provided. On the other glass substrate, color filters having color sections such as red (R), green (G) and blue (B) color sections arranged in a predetermined pattern, counter electrodes, and an alignment film and the like are provided. Image data and control signals that are necessary to display an image are sent to the source lines, the gate lines, and the counter electrodes, from a drive circuit substrate, which is not illustrated. Polarizing plates (not illustrated) are arranged on outer surfaces of the glass substrates.

Next, the backlight device 34 will be explained. As illustrated in FIG. 2, the backlight device 34 includes a housing member 15 including a backlight chassis 32 and a front chassis 16. The housing member 15 houses a LED unit 26, a light guide plate 50 and an optical member 40 therein. The backlight device 34 according to the present embodiment is an edge light type (side light type) backlight device in which the light guide plate 50 is arranged right behind the liquid crystal panel 12, and LEDs 22 (Light Emitting Diode, light source) are arranged on a side end portion of the light guide plate 50.

The backlight chassis 32 has a substantially box-like shape with an opening on the front side (a light exit side, the liquid crystal panel 12 side). The optical member 40 is arranged so as to cover the opening of the backlight chassis 32. The front chassis 16 has a rectangular frame shape having an opening 16a through which the optical member 40 is exposed to the front side. The front chassis 16 is arranged so as to enclose the optical member 40 in a plan view. On an inner peripheral end portion of the front chassis 16, a stepped portion 17 is provided. A peripheral edge portion of the liquid crystal panel 12 is placed on the stepped portion 17. With this configuration, the light exiting from a light exit surface 50A (which will be described later) of the light guide plate 50 passes through the optical member 40, and then is applied to a rear surface of the liquid crystal panel 12 through the opening 16a.

The backlight chassis 32 is made of metal such as an aluminum material. The backlight chassis 32 includes a bottom plate 32a having a rectangular shape in a plan view, and side plates 32b, 32c each of which rises from an outer edge of the corresponding long or short sides of the bottom plate 32a toward the front side. The long side of the bottom plate 32a matches a horizontal direction (X-axis direction) and the short side thereof matches a vertical direction (Y-axis direction). On a rear surface of the bottom plate 32a, a power circuit board (not illustrated) that supplies power to the LED unit 26 is attached, for example.

The LED unit 26 is attached to an inner surface of one of the side plates 32b of the backlight chassis 32 that extends along the long-side direction (X-axis direction) with screws, for example. As illustrated in FIG. 2, the LED unit 26 includes an LED board 24 having a rectangular shape extending along the X-axis direction and the LEDs 22 arranged on the LED board 24 in a straight line. The LEDs 22 are configured to emit white light.

As illustrated in FIG. 3, the LED 22 is arranged such that a light axis LA thereof extends along the direction parallel to a display surface of the liquid crystal panel 12 or a light exit surface 50A of the light guide plate 50 (Y-axis direction). A light emitting surface 22A of the LED 22 faces a side surface (light entrance surface 50D) of the light guide plate 50. The light emitted from the LED 22 radiates three-dimensionally around the light axis LA within a specified angle range and the directivity thereof is higher than that of cold cathode tubes. Namely, angle distributions of the LED 22 show a tendency that the emission intensity of the LED 22 is significantly high along the light axis LA and sharply decreases as the angle to the light axis LA increases.

The LED 22 is configured by sealing LED chips as light emitting elements onto a housing with a resin material. For example, the LED 22 includes three different kinds of LED chips each having a different main emission wavelength. Specifically, each of the LED chips emits a single color of light of red (R), green (G) or blue (B). The LED 22 is not limited to the above configuration, and may have another configuration. The LED 22 may only include an LED chip that is configured to emit light in a single color of blue (B) and covered with a resin containing a phosphor having a light emitting peak in a red (R) range and a phosphor having a light emitting peak in a green (G) range, for example, silicon. Alternatively, the LED 22 may include an LED chip that is configured to emit light in a single color of light of blue (B) and covered with a resin containing a YAG phosphor that emits yellow light, for example, silicon.

The LED board 24 is made of synthetic resin. Surfaces (including a surface facing the light guide plate 50) of the LED board 24 have a white color that provides high light reflectivity. As illustrated in FIG. 2, the LED board 24 has a rectangular plate shape extending along the X-axis direction. The long side of the LED board 24 is slightly shorter than (or substantially the same as) that of the bottom plate 32a. Further, mounting holes (not illustrated) that are through holes are formed in the bottom plate 32a to fix the LED board 24 with screws.

A wiring pattern (not illustrated) made of metal film is provided on the LED board 24 and the LEDs 22 are mounted on predetermined positions of the LED board 24. A control board, which is not illustrated, is connected to the LED board 24. The control board supplies the power required to turn on the LEDs 22 and controls the drive of the LEDs 22.

The light guide plate 50 is a plate-like member having a rectangular shape in a plan view. The long side of the light guide plate 50 extends along the long-side direction (X-axis direction) of the backlight chassis 32. The light guide plate 50 is made of a resin such as acrylic that has a high light transmission (high transparency). As illustrated in FIG. 2, the light guide plate 50 is arranged such that a main plate surface (a light exit surface 50A) thereof faces toward the liquid crystal panel 12 and one of side surfaces (a light entrance surface 50D) faces the light emitting surface 22A of the LED 22. The shape of the light guide plate 50 is not limited to the rectangular shape in a plan view, and may be any other shapes.

A plurality of light reflective portions 51 are provided on a surface 50B (rear surface 50B) of the light guide plate 50 that is opposite from the light exit surface 50A. The light reflective portions 51 are arranged in a dotted pattern having a white color. The light reflective portions 51 are configured to reflect and scatter the light. Accordingly, some of the rays of light that travel toward the light exit surface 50A after being reflected and scattered by the light reflective portions 51 has an entrance angle that is not above the critical angle (some of the rays of light are not reflected), and thus the light can exit toward the liquid crystal panel 12 through the light exit surface 50A. The light reflective portions 51 are, for example, configured by arranging the dots in a zigzag pattern (grid pattern, staggered pattern). The dots are formed by printing metal oxide pastes on the rear surface 50B of the light guide plate 50, for example. Preferable examples of the printing method of the dots include screen printing and ink-jet printing.

With the above configuration, the light emitted from the light emitting surface 22A of each LED 22 enters the light guide plate 50 through the light entrance surface 50D of the light guide plate 50, and then is guided within the light guide plate 50 due to the total reflection and is reflected and scattered by the light reflective portion 51. Thus, the light exits from the light exit surface 50A. Then, the light exiting from the light exit surface 50A is applied to the rear surface of the liquid crystal panel 12 after passing through the optical member 40. The light reflective portions 51 are provided on an area corresponding to the opening 16a of the front chassis 16 (an area overlapping with the opening 16a with a plan view), for example.

A light reflection sheet 30 is arranged on the bottom plate 32a of the backlight chassis 32. The light reflection sheet 30 has a rectangular shape in a plan view. The light reflection sheet 30 is arranged so as to cover almost entire of the rear surface 50B of the light guide plate 50 and a rear surface of the LED unit 26. The light reflective sheet 30 is made of a synthetic resin, for example, and includes a front surface having a white color that provides high light reflectivity. The light exiting from the light guide plate 50 to the light reflective sheet 30 is reflected again toward the light exit surface 50A by the light reflective sheet 30. This improves light use efficiency. The light reflective sheet 30 also has a function of reflecting the light that is emitted from the LED 22 to the light reflective sheet 30 so as to enter the light entrance surface 50D of the light guide plate 50. The material and color, for example, of the light reflective sheet 30 are not limited to those of the present embodiment. Any light reflective sheets that can reflect the light may be used.

The optical member 40 is arranged so as to cover the front surface of the light exit surface 50A of the light guide plate 50. The optical member 40 includes a diffuser sheet 41, a prism sheet 42, and a reflection-type polarizing sheet 43 arranged in this sequence from the light exit surface 50A side. The diffuser sheet 41 may be configured by bonding a diffusion layer including light scattering particles dispersed therein onto a front surface of a light transmissive board made of synthetic resin. The diffuser sheet 41 diffuses the light that exits from the light exit surface 50A. The prism sheet 42 controls the traveling direction of the light that passed through the diffuser sheet 41.

The reflection-type polarizing sheet 43 has a multilayer structure in which layers having different reflective indexes are alternately arranged, for example. The reflection-type polarizing sheet 43 transmits p-wave of the light exiting through the light exit surface 50A and reflects s-wave toward the light guide plate 50. The s-wave reflected by the reflection-type polarizing sheet 43 is reflected again toward the front side by the light reflection sheet 30, for example. At this time, the reflected s-wave separates into s-wave and p-wave. As described above, the reflection-type polarizing sheet 43 allows the s-wave that is normally absorbed by the polarizing plate of the liquid crystal panel 12 to be reused by reflecting the s-wave toward the light guide plate side. This improves light use efficiency (and thus brightness). An example of the reflection-type polarizing sheet 43 is a product named “DBEF” that is manufactured by Sumitomo 3M Limited. The reflection-type polarizing sheet 43 is not limited to the above configuration. Any reflection-type polarizing sheet that allows the rays of light exiting from the light exit surface 50A to be reflected toward the light guide plate 50 to be reused may be employed.

As illustrated in FIG. 2, each of the diffuser sheet 41, the prism sheet 42, and the reflection-type polarizing sheet 43 has a shape corresponds to the light guide plate 50. Specifically, each of them has a rectangular shape extending along the X-axis direction in a plan view. Each of the diffuser sheet 41 and the prism sheet 42 has an area that is substantially the same as the light exit surface 50A of the light guide plate 50 and covers the entire of the front surface of the light exit surface 50A of the light guide plate 50. Compared with this, the reflection-type polarizing sheet 43 has a short side (Y-axis direction) that is shorter than a short side (Y-axis direction) of the light guide plate 50 (as well as the diffuser sheet 41 and the prism sheet 42). The shape of the respective sheets 41 to 43 included in the optical member 40 is not limited to the rectangular shape with a plan view. The respective sheets 41 to 43 may have any shape that can cover at least a part of the front surface of the light exit surface 50 of the light guide plate 50.

As illustrated in FIG. 3, an LED-side peripheral end 43A of the reflection-type polarizing sheet 43 is located farther from the LED 22 (on the right side in FIG. 3) than an LED-side peripheral end of the light guide plate 50 (located aligned with the light entrance surface 50D in the Y-axis direction). Specifically, the LED-side peripheral end 43A of the reflection-type polarizing sheet 43 is arranged on an outer side of the opening 16a of the front chassis 16 (on the left side in FIG. 3). In other words, the LED-side peripheral end 43A of the reflection-type polarizing sheet 43 overlaps with the stepped portion 17 of the front chassis 16 in a plan view.

In other words, the reflection-type polarizing sheet 43 is configured to cover not the entire surface, but a part of the light exit surface 50A of the light guide plate 50. Thus, an LED-side end portion of the light exit surface 50A has a sheet-non-overlapping area T1 where the reflection-type polarizing sheet 43 does not overlap. The sheet-non-overlapping area T1 corresponds to an area defined by the LED-side peripheral end 43A of the reflection-type polarizing sheet 43 and the light exit surface 50D. In the present embodiment, the sheet-non-overlapping area T1 extends along the X-axis direction (an arrangement direction of LEDs 22).

The surfaces of the above front chassis 16 have a black color that provides high light absorption. Thus, the stepped portion 17 that is a part of the front chassis 16 has a black color. The stepped portion 17 is configured as a light absorber that is arranged to face the light exist surface 50A of the light guide plate 50 and cover the sheet-non-overlapping area T1 from the front side. The light absorber may be provided by coloring a surface of the stepped portion 17 that faces the light exit surface 50A of the light guide plate 50 black.

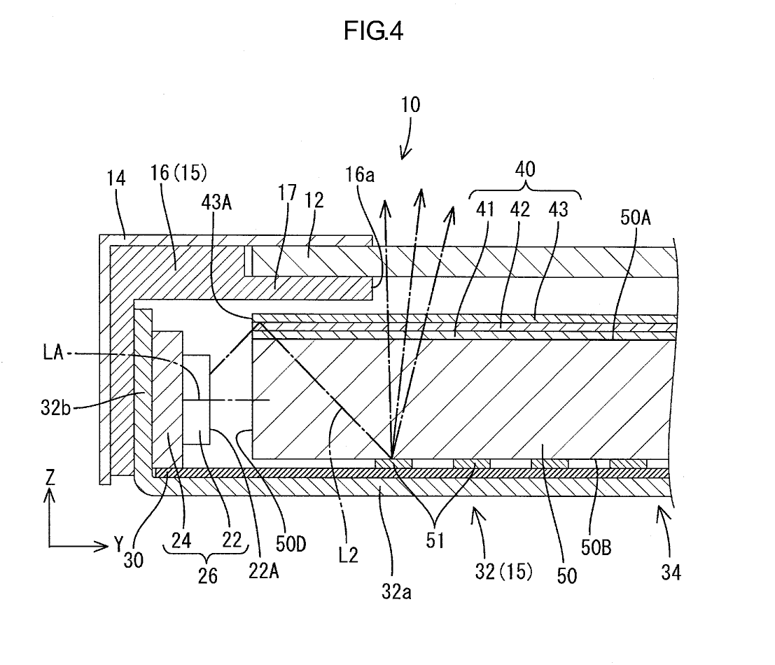

Next, advantages obtained by the present embodiment will be explained. First, an advantage obtained by the sheet-non-overlapping area T1 that is provided at the LED-side end portion of the light exit surface 50A will be explained with reference to FIG. 3 and FIG. 4. FIG. 4 illustrates a comparative example to clarify the advantage obtained by the sheet-non-overlapping area T1. In the comparative example shown in FIG. 4, the LED-side peripheral end 43A of the reflection-type polarizing sheet 43 is located at the same position in the Y-axis direction as the LED-side peripheral end of the light exit surface 50A.

In this configuration, some of the rays of light emitted from the LED 22 may not enter the light entrance surface 50D of the light guide plate 50 and travel more to the front than the light entrance surface 50D (indicated by an arrow L2 in FIG. 4). In such a case, the rays of light may reach an end portion (an LED-side end portion) of the reflection-type polarizing sheet 43. The light L2 reflected by the end portion of the reflection-type polarizing sheet 43 enters the light guide plate 50 through the light exit surface 50A of the light guide plate 50. The light L2 reflected by the light reflection portion 51 scatters and exits from the light exit surface 50A.

Generally, the light guide plate 50 is configured to have a predetermined brightness distribution when the light emitted from the LED 22 enters entirely through the light entrance surface 50D. The light that enters through the other portion than the light entrance surface 50D as above may cause uneven brightness. The light L2 that enters the light guide plate 50 via the reflection-type polarizing sheet 43, which is not the light entrance surface 50D, tends to be concentrated in the LED-side end portion of the light exit surface 50A that is an end portion closer to the LED 22 (in other words, in the vicinity of the opening 16a of the front chassis 16). Accordingly, the brightness of the LED-side end portion increases and uneven brightness may occur.

In view of the above, the backlight device 34 of the present embodiment is configured such that the LED-side end portion of the light exit surface 50A has the sheet-non-overlapping area T1. Some of the rays of light emitted from the LED 22 may not enter the light entrance surface 50D of the light guide plate 50, but travel more to the front than the light entrance surface 50D (indicated by an arrow L1 in FIG. 3). According to the configuration of this embodiment, the rays of light pass through the sheet-non-overlapping portion T1. In other words, the light is not reflected by the end portion of the reflection-type polarizing sheet 43. With this configuration, the light emitted from the LED 22 is less likely to enter the light guide plate 50 through the portion other than the light entrance surface 50D and thus the uneven brightness is less likely to occur due to such light.

Then, the light L1 passing through the sheet-non-overlapping area T1 reaches a rear surface 17B (a surface facing the light guide plate 50) of the stepped portion 17 (light absorber) of the front chassis 16, which covers the sheet-non-overlapping area T1 from the front side. In the present embodiment, the stepped portion 17 has a black color, so that the stepped portion 17 absorbs the light L1 that reaches the rear surface 17B thereof. This suppresses the reflection of the light L1 by the front chassis 16, and thus surely suppresses the entrance of the light L1 into the light guide plate 50.

The backlight device 34 of the present embodiment includes the housing member 15 housing the LEDs 22, the light guide plate 50, and the reflection-type polarizing sheet 43. The light absorber is formed by coloring a part of the housing member 15 (the stepped portion 17) that faces the light exit surface 50A of the light guide plate 50 black. By forming the light absorber by coloring apart of the housing member 15 black, a light absorber as a separate member is not required. Thus, the component cost can be reduced. Note that the part in which the light absorber is formed is not limited to the stepped portion 17.

### Second Embodiment

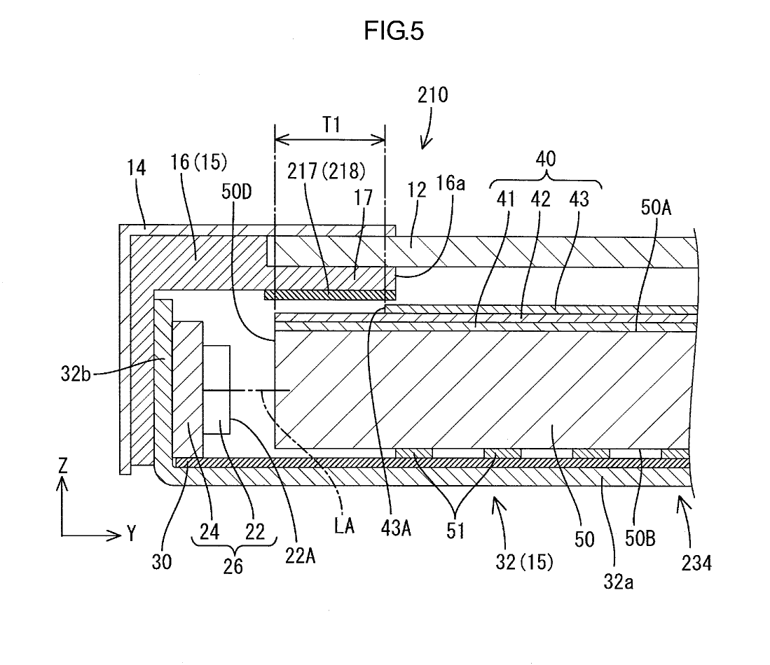

Next, the second embodiment of the present invention will be described with reference to FIG. 5. The parts same as those in the first embodiment described above will be indicated by the same reference symbols and will not be explained. A backlight device 234 of a liquid crystal display 210 according to this embodiment includes alight scattering reflection sheet 217 (light scattering reflector) that covers the sheet-non-overlapping area T1 from the front side.

The light scattering reflection sheet 217 is a light diffusive resin composition in which light diffusive particles including aluminum borate or titanium oxide are dispersed in a base material made of polyethylene terephthalate (PET) resin or polycarbonate (PC) resin, for example. The light scattering reflection sheet 217 is not limited to the above configuration, and may employ any configuration that can scatter and reflect the light. The light scattering reflection sheet 217 is attached to the rear surface of the stepped portion 17. The light scattering reflection sheet 217 has a size that can cover the entire area of the sheet-non-overlapping area T1 from the front side (in other words, a shape elongated in the X-axis direction). Note that the light scattering reflection sheet 217 may be configured to cover only a part of the sheet-non-overlapping area T1.

Some of the rays of light emitted from the LED 22 may not enter the light entrance surface 50D, but reach the light exit surface 50A side (the front side of the light guide plate 50). According to the configuration of this embodiment, the rays of light are reflected and scattered by the light scattering reflection sheet 217 toward the light guide plate 50 after passing through the sheet-non-overlapping area T1. By reflecting and scattering the rays of light that do not enter the light entrance surface 50D, the light is less likely to appear locally on the light exit surface 50A of the backlight device 234. In addition, the light use efficiency is improved since the light that does not enter the light entrance surface 50D is reused by the reflection toward the light guide plate 50.

Instead of providing the light scattering reflection sheet 217, the light scattering reflector may be formed by printing a paste having a function of reflecting and scattering the light (for example, metal oxide paste having a white color) on the rear surface of the stepped portion 17.

Alternatively, a light absorptive sheet 218 (light absorber) may be provided instead of the light scattering reflection sheet 217. The light absorptive sheet 218 may include a plate made of PET resin having a surface colored black that provides high light absorption. Some of the rays of light emitted from the LED 22 may not enter the light entrance surface 50D of the light guide plate 50 and reach the space between the light exit surface 50A and the reflection-type polarizing sheet 43. According to the configuration of this embodiment, the light is absorbed by the light absorptive sheet 218. This suppresses that the rays of light that do not enter the light entrance surface 50D is reflected by the reflection-type polarizing sheet 43. Thus, the light is less likely to appear locally on the light exit surface 50A, leading to the suppression of the uneven brightness. Note that the light absorptive sheet 218 is not limited to the above configuration, and may employ any configuration that can absorb light.

### Third Embodiment

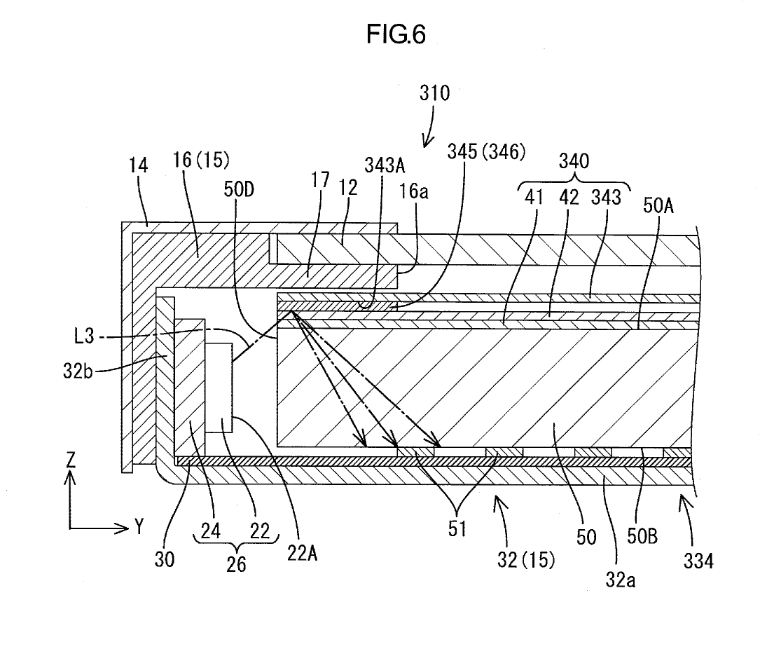

Next, the third embodiment of the present invention will be described with reference to FIG. 6. The parts same as those in the embodiments described above will be indicated by the same reference symbols and will not be explained. A backlight device 334 of a liquid crystal device 310 according to this embodiment includes an optical member 340 having a different configuration from the optical members in the above embodiments. As illustrated in FIG. 6, the optical member 340 of the present embodiment includes a reflection-type polarizing sheet 343 that has the same size as the diffuser sheet 41 and the prism sheet 42.

A light scattering reflection sheet 345 (light scattering reflector) is arranged between the reflection-type polarizing sheet 343 and the prism sheet 42. The light scattering reflection sheet 345 is, for example, a light diffusive resin composition in which light diffusive particles including aluminum borate or titanium oxide are dispersed in a base material made of polyethylene terephthalate (PET) resin or polycarbonate (PC) resin, for example.

The light scattering reflection sheet 345 has a shape elongated in the X-axis direction (the arrangement direction of the LEDs 22). The light scattering reflection sheet 345 is arranged on a rear surface 343A of the reflection-type polarizing sheet 343 (a light-source-side surface of the reflection-type polarizing sheet) so as to cover the LED-side peripheral end portion of the reflection-type polarizing sheet 343. A right peripheral end of the light scattering reflection sheet 345 in FIG. 6 (the peripheral end located at an inner side of the light guide plate 50) is located at substantially the same position as (or inner side of) an inner peripheral end of the front chassis 16 (opening 16a).

Some of the rays of light (indicated by an arrow L3 in FIG. 6) emitted from the LED 22 may not enter the light entrance surface 50D of the light guide plate 50, but reach the space between the light exit surface 50A and the reflection-type polarizing sheet 343. According to the configuration of this embodiment, the light L3 is reflected and scattered by the light scattering reflection sheet 345 toward the light guide plate 50. By reflecting and scattering the rays of light that do not enter the light entrance surface 50D, the light is less likely to appear locally on the light exit surface 50A. Thus, uneven brightness is less likely to occur.

Instead of providing the light scattering reflection sheet 345, the light scattering reflector may be formed by printing a paste having a function of reflecting and scattering the light (for example, metal oxide paste having a white color) on the LED-side peripheral end portion of the rear surface (the light-source-side surface) of the reflection-type polarizing sheet 343.

Alternatively, alight absorptive sheet 346 (light absorber) may be provided instead of the light scattering reflection sheet 345. The light absorptive sheet 346 may include a plate made of PET resin having a surface colored black that provides high light absorption. The light absorptive sheet 346 is not limited to the above configuration, but may employ any configuration that can absorb light. Some of the rays of light emitted from the LED 22 (indicated by an arrow L3 in FIG. 6) may not enter the light entrance surface 50D of the light guide plate 50, but reach the space between the light exit surface 50A and the reflection-type polarizing sheet 343. According to the configuration of this embodiment, the light L3 is absorbed by the light absorptive sheet 346. This suppresses that the light L3 is reflected by the reflection-type polarizing sheet 343. Thus, the light L3 is less likely to appear locally on the light exit surface 50A, leading to the suppression of the uneven brightness.

Instead of the light absorptive sheet 346, a light shielding sheet that has low light absorption may be used. The light shielding sheet can prevent the rays of light that do not enter the light entrance surface 50D from reaching the LED-side peripheral end portion of the rear surface of the reflection-type polarizing sheet 343. Thus, the rays of light that do not enter the light entrance surface 50D are less likely to be reflected by the rear surface of the reflection-type polarizing sheet 343.

### Other Embodiments

The present invention is not limited to the embodiments explained in the above description with reference to the drawings. The following embodiments may be included in the technical scope of the present invention, for example.

(1) In the above embodiments, the LED unit 26 is provided on only one of the side plates 32b, 32c of the backlight chassis 32, but may be provided on two or more of the side plates 32b, 32c. In such a case, each of the peripheral end portions of the reflection-type polarizing sheet 43 that faces the corresponding LED unit 26 (LEDs 22) includes the sheet-non-overlapping area T1.

(2) In the above third embodiment, the light scattering reflection sheet 345 (or the light absorptive sheet 346) is arranged between the reflection-type polarizing sheet 343 and the prism sheet 42, but not limited to this configuration. The light scattering reflection sheet 345 (light scattering reflector) or the light absorptive sheet 346 (light absorber) may have any configuration that covers the LED-side peripheral end portion of the rear surface (the light-source-side surface) of the reflection-type polarizing sheet 343. The light scattering reflection sheet 345 (or the light absorptive sheet 346) may be arranged between the diffuser sheet 41 and the prism sheet 42.

(3) The backlight chassis 32 and the front chassis 16 included in the housing member 15 may be an integral member.

(4) The configuration of the optical member 40, 340 is not limited to the above embodiments. The optical member 40, 340 may include a diffuser plate or a lens sheet. All that is required for the optical member 40, 340 is to include the reflection-type polarizing sheet. Any other sheet than the reflection-type polarizing sheet may be provided or may not be provided. In addition, the number of such sheet may be suitably determined.

(5) In the above embodiments, the LED 22 (light emitting diode) is used as a light source, but light sources other than LED such as a cold cathode tube may be used.

(6) In the above embodiments, TFTs are used as switching components of the liquid crystal display device. However, the technology described above can be applied to liquid crystal display devices including switching components other than TFTs (e.g., thin film diode (TFD)). Moreover, the technology can be applied to not only color liquid crystal display devices but also black-and-white liquid crystal display devices.

(7) In the above embodiments, the liquid crystal display device including the liquid crystal panel as a display panel is used. The technology can be applied to display devices including other types of display panels.

(8) In the above embodiments, the television receiver including the tuner is used. However, the technology can be applied to a display device without a tuner.

### EXPLANATION OF SYMBOLS

10, 210, 310: liquid crystal display device (display device), 12: liquid crystal panel (display panel), 15: housing member, 17: stepped portion (portion facing light exit surface of light guide plate), 22: LED (light source), 22A: light emitting surface, 34, 234, 334: backlight device (lighting device), 43, 343: reflection-type polarizing sheet, 43A: LED-side peripheral end (light-source-side peripheral end of reflection-type polarizing sheet), 50: light guide plate, 50A: light exit surface, 50D: light entrance surface, 217: light scattering reflection sheet (light scattering reflector arranged to cover sheet-non-overlapping area), 218: light absorptive sheet (light absorber arranged to cover sheet-non-overlapping area), 343A: rear surface of the reflection-type polarizing sheet (light-source-side surface of reflection-type polarizing sheet), 345: light scattering reflection sheet (light scattering reflector arranged to cover light-source-side peripheral end portion of reflection-type polarizing sheet), 346: light absorptive sheet (light absorber arranged to cover light-source-side peripheral end portion of reflection-type polarizing sheet), T1: sheet-non-overlapping area, TV: television receiver

1. A lighting device comprising:
a light source having a light emitting surface;
a light guide plate having a light entrance surface and a light exit surface, the light entrance surface facing the light emitting surface of the light source and through which light emitted from the light source enters the light guide plate, the light exit surface through which the light in the light guide plate exits; and
a reflection-type polarizing sheet covering at least a part of the light exit surface of the light guide plate,
wherein the reflection-type polarizing sheet is arranged such that a light-source-side peripheral end thereof is located farther from the light source than a light-source-side peripheral end of the light guide plate, whereby a peripheral end portion of the light guide plate has a sheet-non-overlapping area that does not overlap with the reflection-type polarizing sheet.

2. The lighting device according to claim 1, further comprising a light absorber configured to absorb light, the light absorber being arranged so as to cover the sheet-non-overlapping area.

3. The lighting device according to claim 2, further comprising a housing member configured to house the light source, the light guide plate, and the reflection-type polarizing sheet, wherein the light absorber is a part of the housing member that faces the light exit surface of the light guide plate and has a black color.

4. The lighting device according to claim 1, further comprising a light scattering reflector member configured to reflect and scatter light, the light scattering reflector being arranged so as to cover the sheet-non-overlapping area.

5. A lighting device comprising:
a light source having a light emitting surface;
a light guide plate having a light entrance surface and a light exit surface, the light entrance surface facing the light emitting surface of the light source and through which light enters the light guide plate, the light exit surface through which the light in the light guide plate exits;
a reflection-type polarizing sheet covering at least a part of the light exit surface of the light guide plate; and
a light scattering reflector configured to reflect and scatter light, the light scattering reflector being arranged so as to cover a light-source-side peripheral end portion of a light-source-side surface of the reflection-type polarizing sheet.

6. A lighting device comprising:
a light source having a light emitting surface;
a light guide plate having a light entrance surface and a light exit surface, the light entrance surface facing the light emitting surface of the light source and through which light enters the light guide plate, the light exit surface through which the light in the light guide plate exits;
a reflection-type polarizing sheet covering at least a part of the light exit surface of the light guide plate; and
a light absorber configured to absorb light, the light absorber being arranged so as to cover a light-source-side peripheral end portion of a light-source-side surface of the reflection-type polarizing sheet.

7. The lighting device according to claim 1, wherein the light source is an LED.

8. A display device comprising:
the lighting device according to claim 1; and
a display panel configured to provide display using light from the lighting device.

9. The display device according to claim 8, wherein the display panel is a liquid crystal panel using liquid crystals.

10. A television receiver comprising the display device according to claim 8.
